(19) United States
(12) Patent Application Publication
(10) Pub. No.: US 2009/0107622 A1
(43) Pub. Date: Apr. 30, 2009

(54) METHOD OF PRODUCING CUT-AND-STACK LABELS

(76) Inventors: James D. Combs, Winchester, KY (US); John David Enoch, Mt. Sterling, KY (US); Tommie Joe Keeney, Mt. Sterling, KY (US)

Correspondence Address: KING & SCHICKLI, PLLC, 247 NORTH BROADWAY, LEXINGTON, KY, 40507, US

(21) Appl. No.: 11/925,074

(22) Filed: Oct. 26, 2007

(51) Int. Cl. B32B 38/04

(52) U.S. Cl. 156/250

(57) ABSTRACT

A method is provided of producing cut-and-stack labels from a web of printing stock. The method includes the steps of printing indicia on a first face of the web, laminating a protective film to the web over the printed first face, applying an antistat to the laminated web and drying the antistat. This is followed by the slitting of the web into at least two narrow webs. The narrow webs are then dusted with an offset powder, cut into sheets of predetermined length and finished into cut-and-stack labels.

### TECHNICAL FIELD

The present invention relates generally to the product labeling field and, more particularly, to an improved method of producing cut-and-stack labels from a continuous web of printing stock.

### BACKGROUND OF THE INVENTION

There is a crowing consumer preference for food, beverage and household products packaged in plastic containers. This is because plastic containers offer the consumer a number of convenient benefits including, but not limited to, portability, resealability, safety, lightweight and contourability for a comfortable grip.

Plastic containers pose several challenges for packaged good companies and label manufacturers. One of the main reasons for this is that plastic containers are particularly durable and can withstand more demanding consumer environments, such as an ice chest as well as withstand a drop to the ground of perhaps six feet or more. Further, a plastic container's portability means it can be used and the product consumed over a long period of time including days and weeks, not hours.

For label manufacturers, this means packaged goods companies prefer labels to be 100% water proof, 100% scuff proof, extremely durable, resistant to scuffing and product deterioration, able to withstand drops of six feet or more without tearing and be aesthetically pleasing to the consumers eye and touch for the life of the use of the plastic container.

U.S. patent application Ser. No. 10/482,539 entitled Cut and Stack Labels of Laminated Film (owned by the assignee of the current invention) discloses a laminated polymer film printing stock label particularly well suited for modern labeling applications. The present invention relates to a method for more efficiently producing such labels in mass quantities.

### SUMMARY OF THE INVENTION

In order to achieve the foregoing and in accordance with the purposes of the present invention as described herein, an improved method is provided for producing cut-and-stack labels from a web of printing stock. The method may be broadly described as comprising the steps of: (a) printing indicia on a first face of the web; (b) laminating a protective film to the web over the printed face; (c) applying an antistat to the laminated web; (d) drying the antistat; (e) slitting the web into at least two narrow webs; (f) dusting the narrow webs with an offset powder; (g) cutting the narrow webs into sheets of predetermined length; and (h) finishing the cut-and-stack labels. Typically the finishing including cutting individual cut-and-stack labels from the sheets and stacking the individual cut-and-stack labels.

In addition the method may include the steps of using a spray jet to apply antistat to the laminated web. Further the method may include using a wax less antistat formulation particularly suited for spray jet application. Further the method may include the selecting of an offset powder from a group of materials consisting of cornstarch, baby powder, talc and mixtures thereof. Still further the method may include the stacking of the narrow webs after slitting and before cutting into sheets of predetermined length.

Alternatively, the method may be described as the producing of cut-and-stack labels from a continuous web of printing stock having a longitudinal axis and a width W. The method includes feeding the continuous web of printing stock in a direction parallel to the longitudinal axis and printing indicia on a first face of the web. This is followed by laminating a protective film to the continuous web of printing stock over the printed first face.

The method then includes the applying of an antistat to the laminated continuous web of printing stock and the drying of that antistat. This is followed by the slitting of the printed, laminated and antistat treated continuous web of printing stock in a longitudinal direction in order to produce at least two narrow webs having a width w where w<W. The method then includes the steps of dusting the narrow webs with an offset powder, cutting the narrow webs into sheets of predetermined length and finishing the cut-and-stack labels. The width w of the narrow webs is W/n where n is an integer between 2 and 6 and most typically is W/2.

Still other benefits and advantages of the present invention will become readily apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawing incorporated herein and forming a part of the specification, illustrates several aspects of the present invention and together with the description serve to explain certain principles of the invention. In the drawings:

FIG. 1 is a schematical edge elevational view of a label constructed in accordance with the teachings of the present invention; and

FIG. 2 is a schematical side elevational view illustrating in-line processing steps in order to make cut-and-stack labels of the present invention.

Reference will now be made in detail to the present preferred embodiment of the invention, an example of which is illustrated in the accompanying drawings.

### DETAILED DESCRIPTION OF THE PREFERRED EMBODIMENTS OF THE INVENTION

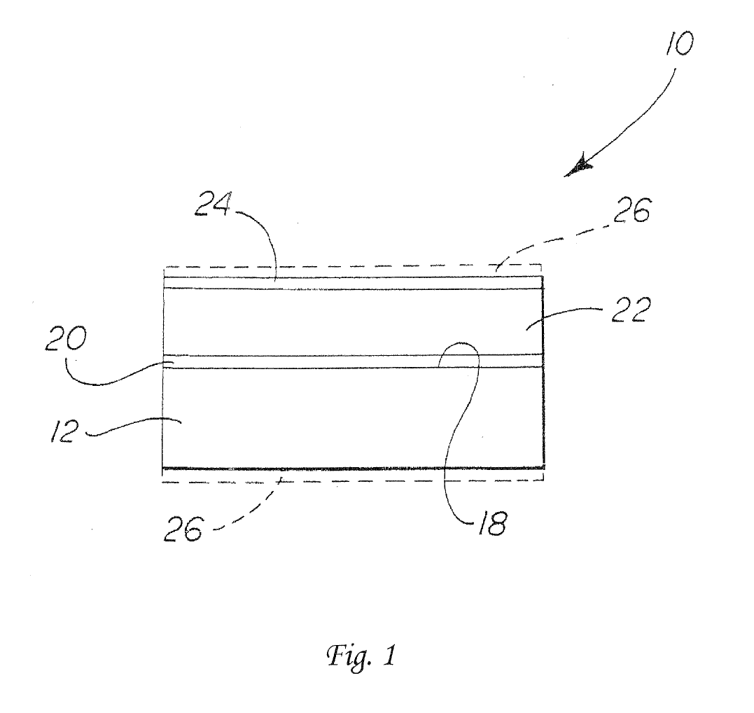

Reference is now made to drawing FIG. 1 clearly illustrating a cut-and-stack label 10 made in accordance with the method of the present invention. That label 10 comprises a layer of polymer film printing stock 12 which may be constructed from polypropylene, polyethylene, polystyrene, polyvinyl chloride, polyethylene terephthalate, polytetrafluoroethylene, polyvinylidene fluoride, polyvinylidene chloride, polyester, nylon, mineral enhanced polymer and any mixture thereof. Preferably the polymer film printing stock 12 has a thickness of at least 0.5 mil and more typically between 0.5 mil-4.0 mil in order to provide the necessary stiffness to allow the label 10 to be used in existing cut and stack labeling equipment. The polymer film printing stock 12 may be opaque. Of course, other alternatives are possible including but not limited to clear, hologram and metallized. The polymer film printing stock 12 could be white, black or any other color, which might be desired by a product packager.

A first face 18 of the polymer film printing stock 12 is printed with indicia and carries a message in ink or other means suitable for application to the printing stock. A clear drying adhesive layer 20 (such as HBFuller WD4120:WD4125) is applied to the printed face 18 of the printing stock 12 and/or the back side of a clear polymer film 22 and the clear polymer film is laminated to the printing stock 12 by the setting adhesive. The clear polymer film 22 may be made from polypropylene, polyethylene, polystyrene, polyvinyl chloride, polyethylene terephthalate, polytetrafluoroethylene, polyvinylidene fluoride, polyvinylidene chloride, polyester, nylon and mixtures thereof. Typically the clear polymer film 22 is provided in a thickness of between 0.5 mil-4.0 mil. Together, the polymer film printing stock 12 and the clear polymer film 22 are of a sufficient thickness and strength to provide the necessary stiffness to help support operation in existing cut and stack labeling equipment. Additionally, the clear polymer film 22 provides the desired durability and scuff protection to protect the message printed on the face 18 of the printing stock 12 from damage during packaging, shipping, sale, and use by the consumer.

If desired, a cold glue receptive coating may be applied to the backside or second face of the printing stock 12 before the application of inks and lamination. The coating is a water-based polymeric coating that is cured by evaporative drying. The coating improves drying during the application of the cold glue label adhesive. An example of such a coating is available from RoyMal, Inc. of Newport, N.H.

A first anti-static coating 24 is provided on the exposed face of the clear film 22. The first anti-static coating 24 has a formulation comprising from about 2.0-6.0% anti-static agent (e.g. Armac 1019, available from Akzo Nobel Surface Chemistry, LLC of Chicago, Ill.), 0-0.3% defoamer and the remainder is solvent. This solvent may be selected from a group consisting of water, alcohol and any mixture thereof. A typical alcohol utilized as a solvent in an anti-static formulation of the type being described is isopropyl alcohol.

In accordance with yet another aspect of the invention, an offset powder dusting or layer 26 is applied to the clear polymer film 22 over the first anti-static coating 24 and/or directly to the second face of the printing stock 12. The offset powder dusting or layer 26 may be substantially any powder exhibiting the desired lubricating properties so as to aid in separating the individual stacked labels so that they may be fed easily through the labeling machine. Useful offset powders include but are not limited to cornstarch, baby powder, talc and mixtures thereof. For example, #375 coated 30-micron powder available from Oxy-Dry of Itasca, Ill., may be utilized as the offset powder.

The anti-static coating 24 and the offset powder layer 26 on the upper face of the label 10 provide sufficient lubricating and anti-static properties to allow ready separation of stacked labels 10 in existing cut and stack labeling equipment. Thus, the labels 10 have the necessary stiffness and anti-static properties to operate efficiently and reliably in existing cut and stack labeling equipment. Further, the labels 10 beneficially provide the properties desired by packaged goods manufacturers utilizing plastic containers. Specifically, the labels 10 are 100% waterproof, extremely durable by being resistant to scuffing and product deterioration and able to withstand drops of six feet or more without tearing, and are aesthetically pleasing to the consumer's eye and touch for the foreseeable useful life of the container. Further, the labels 10 may be manufactured in a cost effective manner competitive in today's marketplace.

The method of producing the cut-and-stack labels 10 from a web of printing stock includes the steps of: (a) printing indicia on a first face of the web; (b) laminating a protective film to the web over the printed first face; (c) applying an antistat to the laminated web; (d) drying the antistat; (e) slitting the web into at least two narrow webs; (f) dusting the narrow webs with an offset powder; (g) cutting the narrow webs into sheets of predetermined length; and (h) finishing the cut-and-stack labels. Finishing includes cutting individual cut-and-stack labels from the sheets and stacking the individual cut-and-stack labels.

More specifically describing the production method, pre-pressed stage steps include making the printing plates, printing inks and selecting the polymer film for the printing stock.

The printing press stage steps include feeding the polymer film printing stock in continuous web form longitudinally into the printing press. Specifically, as is known in the art, the printing press is composed of an unwind unit for feeding stock into the press, a number of print units and a rewind unit for delivering printed stock out of the press. Each print unit consists of (a) a number of printing cylinders for feeding the printing stock through the press, for applying ink to the printing plate and for transferring ink to the front face of the stock and (b) a drying and/or curing unit that dries the ink, coating or adhesive utilizing either hot air drying or ultraviolet curing.

At the first and each subsequent printing unit, ink of a particular color is applied to the first or print face 18 of the polymer film printing stock 12. Through the application of ink at each printing unit, the printed image of the label is created.

At the second to last printing unit, an adhesive 20 is applied to the first face 18 of the printing stock 12 over the printed image. The polymer film printing stock 12 is then nipped to a web of clear polymer film 22 that is fed into the printing press for laminating to the printing stock. Following the nip, the laminated/printed roll is staged for twenty-four hours to allow for proper curing.

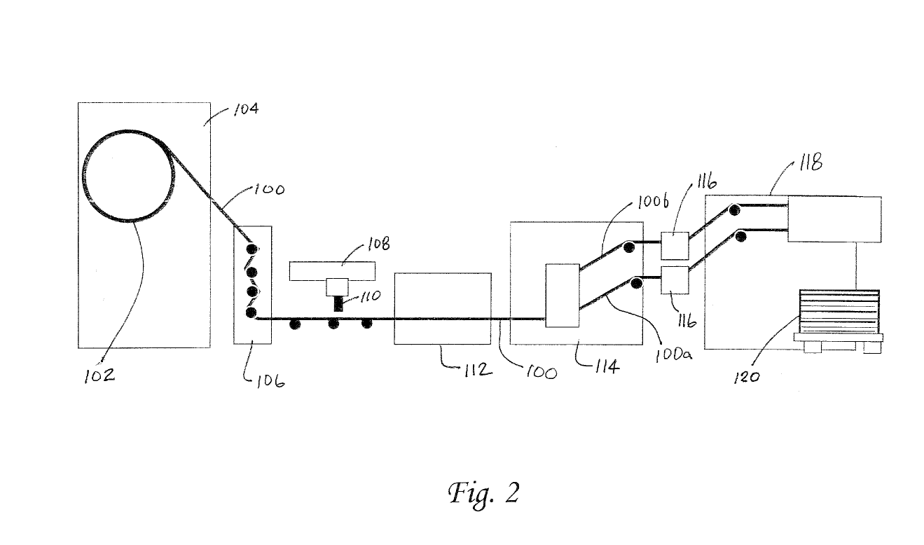

Following curing the laminated/printed supply roll 102 is webbed for further processing. More specifically, as illustrated in FIG. 2 the continuous web 100 is fed from the supply roll 102 on the web feeder 104 (such as a 50″ KTI unwind machine) through the web guide 106 to the auto-spray unit 108. Auto-spray unit 108 includes a series of spray jets 110 for evenly applying an antistat formulation over the entire width W of the continuous web of printing stock 100. Preferably, the antistat formulation is a wax less formulation particularly suited for spray jet application. A particularly useful formulation comprises 1.4% antistat solution RAW 104693-540, 10.0% isopropyl alcohol, 3.0% RMAC 1019 antistatic agent and 85.60% water. The continuous web 100 is then fed through a drying tunnel 112 in order to dry the antistat on the surface of the web. Next the continuous web 100 is fed through an angle bar system 114 such as a VITS angle bar slitter and converter. In this device the continuous web 100 is slit in a longitudinal direction so as to provide two narrow webs 100a, 100b having a width w where w=W/2. The two narrow webs 100a, 100b are vertically stacked and then fed to two separate powder boxes 116. There each of the narrow webs 100a, 100b is dusted with an offset powder such as cornstarch, baby powder, talc or mixtures thereof. The dusted narrow webs 100a, 100b are then fed to a sheeting device such as a VITS sheeter. There the stacked, narrow webs 100a, 100b are cut into sheets of a predetermined length that are stacked and staged on a skid for finishing as illustrated by reference number 120.

Each skid of sheets 120 is jogged, inspected, separated into increments of 1000 sheets, cut, banded and packaged in a box. The sheets are jogged in a jogging machine that vibrates the sheets so that the sheets are aligned to each other for accurate cutting. At the jogging machine, separation of the sheets into lift counts of one thousand sheets is determined using a weighing scale.

After jogging, the lift of one thousand sheets is transferred via air tables to a cutting machine that cuts the one thousand sheets into bundles of one thousand individual labels 10. After the cutting machine, the bundled one thousand individual labels 10, now in cut and stacked form, are packaged together and placed in a box for storage and shipment. A bundle of labels 10 can be packaged in a number of ways including banded, string tied or shrink-wrapped.

In summary, numerous benefits result from employing the concepts of the present invention. By completing the printing, laminating and antistat treating steps, before slitting the web longitudinally, production speeds are increased and less labor is required per unit of printed material. The use of a waxless antistat formulation and spray jet applicators ensure a better and more consistent application of antistat across the entire web.

The foregoing description of the preferred embodiments of the invention has been presented for purposes of illustration and description. It is not intended to be exhaustive or to limit the invention to the precise form disclosed. Obvious modifications or variations are possible in light of the above teachings. The embodiments was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of producing cut-and-stack labels from a web of printing stock, comprising:
printing indicia on a first Face of said web;
laminating a protective film to said web over said printed first face;
applying an antistat to said laminated web;
drying said antistat;
slitting said web into at least two narrow webs;
dusting said narrow webs with an offset powder;
cutting said narrow webs into sheets of predetermined length; and
finishing said cut-and-stack labels.

2. The method of claim 1, including using a spray jet to apply antistat to said laminated web.

3. The method of claim 2, including using a waxless antistat formulation.

4. The method of claim 1, wherein finishing includes cutting individual cut-and-stack labels from said sheets and stacking said individual cut-and-stack labels.

5. The method of claim 4, including selecting said offset powder from a group of materials consisting of cornstarch, baby powder, talc and mixtures thereof.

6. The method of claim 1, including stacking said narrow webs after slitting and before cutting into sheets of predetermined length.

7. A method of producing cut-and-stack labels from a continuous web of printing stock having a longitudinal axis and a width W, comprising:
feeding said continuous web of printing stock in a direction parallel to said longitudinal axis;
printing indicia on a first face of said web;
laminating a protective film to said continuous web of printing stock over said printed first face;
applying an antistat to said laminated continuous web of printing stock;
drying said antistat;
slitting said printed, laminated and antistat treated continuous web of printing stock in a longitudinal direction into at least two narrow webs having a width w where w<W;
dusting said narrow webs with an offset powder;
cutting said narrow webs into sheets of predetermined length; and
finishing said cut-and-stack labels.

8. The method of claim 7, including using a spray jet to apply antistat to said laminated web.

9. The method of claim 8, including using a waxless antistat formulation.

10. The method of claim 7, wherein finishing includes cutting individual cut-and-stack labels from said sheets and stacking said individual cut-and-stack labels.

11. The method of claim 10, including selecting said offset powder from a group of materials consisting of cornstarch, baby powder, talc and mixtures thereof.

12. The method of claim 7, including stacking said narrow webs after slitting and before cutting into sheets of predetermined length.

13. The method of claim 7, including selecting said width w from a group of widths including W/n wherein n is an integer between 2 and 6.

14. The method of claim 7, wherein said width w=W/2.
